(19) United States
(12) Patent Application Publication
(10) Pub. No.: US 2008/0026696 A1
(43) Pub. Date: Jan. 31, 2008

(54) Method and system for transmitting voice data by using wireless LAN and bluetooth

(76) Inventors: Hyo Jin Choi, Kwangmyung City (KR); Jin Hwan Jeon, Seoul (KR); Dae Hong Kim, Seoul (KR); Kyeongho Lee, Seoul (KR); Sang Min Shim, Seoul (KR); Won Hoeh Song, Seoul (KR); Jeong Min Kim, Seoul (KR)

Correspondence Address: THE FLESHNER GROUP, PLLC, P.O. BOX 1397, ASHBURN, VA, 20146-9998, US

(21) Appl. No.: 11/878,939

(22) Filed: Jul. 27, 2007

(30) Foreign Application Priority Data
Jul. 28, 2006 (KR) 10-2006-0071212

(51) Int. Cl. H04B 7/00

(52) U.S. Cl. 455/41.3

(57) ABSTRACT

Embodiments of methods and systems according to the application can transmit voice data by using a wireless LAN and a Bluetooth. One system embodiment can include a headset, an AP, and a terminal device to communicate with the headset according to a first protocol (e.g., Bluetooth) to transmit downlink voice data to the headset and to receive uplink voice data from the headset and to communicate with the AP according to a second protocol (e.g., wireless LAN) to transmit the uplink voice data to the AP and to receive the downlink voice data from the AP. The terminal device can receive the downlink voice data from the AP after the terminal device sends a PS-Poll frame to the AP within a period during which a transmission/reception between the terminal device and the headset is not to be performed.

### FIELD OF THE INVENTION

The application relates to methods and systems for a data transmission that allows a headset to transmit/receive data to/from an AP (access point) and a terminal device for use therein.

### BACKGROUND OF THE INVENTION

Recently, with a rapid spread of a wireless LAN, a telephone call using the wireless LAN is being tried. The telephone call using the wireless LAN is referred to as VoWLAN (voice over wireless LAN). Moreover, as the Bluetooth technique has been spread, it is being increased to listen music or to speak to a person over the telephone by using a headset wirelessly connected to a terminal device such as a notebook computer, a cellular phone or the like.

As described above, the related art has various disadvantages. During a telephone call, the terminal device is connected to a network through the wireless LAN while the terminal device is connected with the headset by using the Bluetooth. A conflict can occur since the wireless LAN may use the same frequency band as the Bluetooth. For example, since both the wireless LAN and the Bluetooth use an unlicensed 2.4 GHz ISM (industrial, scientific and medical) frequency band, the terminal device cannot communicate with the headset through the use of the Bluetooth when a station, e.g., the terminal device, is communicating with the AP by using the wireless LAN. Further, a communication between the terminal device and the AP cannot also be carried out through the wireless LAN when the terminal device is communicating with the headset by using the Bluetooth. In order to perform a real-time voice telephone call, however, a process of transmitting voice data between the terminal device and the AP and a process of transmitting voice data between the terminal device and the headset have to be repeated. Therefore, systems and methods are needed to manage resources efficiently.

### SUMMARY OF THE INVENTION

An object of embodiments of the application is to solve at least the problems and/or disadvantages in the related art or to provide at least the advantages described herein in whole or in part.

Another object of embodiments is to provide voice data transmission methods and voice data transmission systems that allow a headset wirelessly coupled with a terminal device to transmit voice data to an AP and to receive voice data from the AP via the terminal device by managing resources of first communication type (e.g., a wireless LAN) and a second communication type (e.g., Bluetooth) using the same frequency band.

To achieve objects of embodiments of the application in whole or in part, there is provided a voice data transmission method in a system including a terminal device, a headset to communicate with the terminal device according to a Bluetooth protocol and an access point (AP) to communicate with the terminal device according to a wireless LAN protocol that can include performing a first communication between the terminal device and the headset during a first period of a cycle, performing a second communication between the terminal device and the AP during a second period of the cycle, the second period being the remaining period from the cycle except the first period, the second communication including receiving downlink voice data from the AP by the terminal device and repeating the performing a first communication and the performing a second communication, wherein the receiving downlink voice data from the AP by the terminal device, includes transmitting a PS-Poll (power save poll) frame to the AP by the terminal device, and receiving the downlink voice data from the AP by the terminal device in response to the PS-Poll frame.

To achieve objects of embodiments of the application in whole or in part, there is provided a system, that can include a headset, an access point (AP) and a terminal device to communicate with the headset according to a Bluetooth protocol to transmit downlink voice data to the headset and to receive uplink voice data from the headset and to communicate with the AP according to a wireless LAN protocol to transmit the uplink voice data to the AP and to receive the downlink voice data from the AP, the terminal device to send a power save poll (PS-Poll) frame to the AP to receive the downlink voice data from the AP responsive to the PS-Poll frame both within a period during which a transmission/reception between the terminal device and the headset is not to be performed.

To achieve objects of embodiments of the application in whole or in part, there is provided A terminal device that can include a Bluetooth baseband processor, a wireless LAN baseband processor to transmit/receive data to/from the Bluetooth baseband processor, an RF circuit coupled to the Bluetooth baseband processor and the wireless LAN baseband processor, an antenna coupled to the RF circuit and a resource scheduler to control the Bluetooth baseband processor to repeatedly perform a transmission and a reception, and to control the wireless LAN baseband processor to perform a transmission and a reception only within a period (during which the Bluetooth baseband processor does not perform the transmission and the reception), said resource scheduler to control the wireless LAN baseband processor to transmit a PS-Poll frame to an access point (AP) and receive data from the AP within said period.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The embodiments will be described in detail with reference to the following drawings in which like reference numerals refer to like elements wherein:

FIG. 1 is a diagram that shows a voice data transmission system in accordance with an embodiment of the application;

FIG. 2 is a block diagram that shows an example of a terminal device shown in FIG. 1;

FIGS. 3(a)-3(b) are diagrams that show a voice data transmission method in accordance with a first embodiment of the application; and

FIGS. 4(a)-4(b) are diagrams that show a voice data transmission method in accordance with a second embodiment of the application.

### DETAILED DESCRIPTION OF THE PREFERRED EMBODIMENTS

Embodiments according to the application will be described with reference to the accompanying drawings. Such embodiments are exemplary and not to be construed as limiting. Many alternatives, modifications, and variations will be apparent to those skilled in the art.

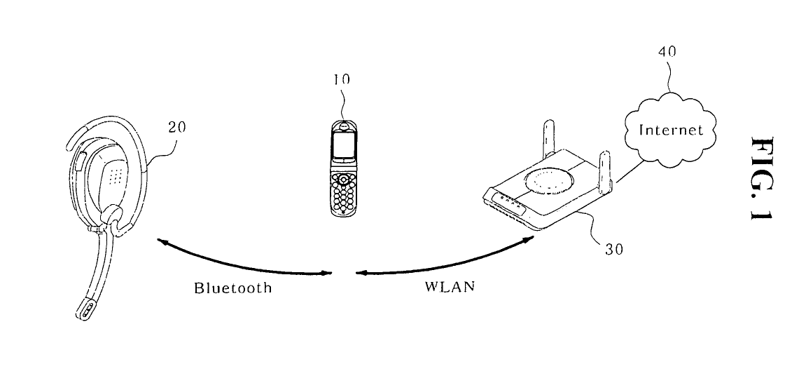

FIG. 1 is a diagram that shows a voice data transmission system in accordance with an embodiment of the application. As shown in FIG. 1, the voice data transmission system can include a terminal device 10, a headset 20 and an AP 30.

The terminal device 10 can carry out a communication with the headset 20 according to a Bluetooth protocol to transmit downlink voice data to the headset 20 and receive uplink voice data from the headset 20. The headset 20 can perform a Bluetooth communication with the terminal device 10 and can include a speaker and a microphone to enable a voice telephone conversation. The terminal device 10 can be an apparatus capable of performing a wireless LAN communication (e.g., first communication) and a Bluetooth communication (e.g., second communication) and, for example, it may be a notebook, a cellular phone, a PDA (personal digital assistant) or the like. However, embodiments of the application are not intended to be limited by such an exemplary disclosure.

The terminal device 10 can communicate with the AP 30 according to a wireless LAN protocol to transmit uplink voice data to the AP 30 and receive downlink voice data from the AP 30. The AP 30 can be coupled to a network 40 or the like, to transmit and receive data (e.g., voice) for a wireless or telephone conversation.

In order to receive downlink voice data from the AP 30 in the system shown in FIG. 1, during a period within which a transmission/reception operation between the terminal device 10 and the headset 20 is not carried out, the terminal device 10 can receive the downlink voice data from the AP 30. For example, the terminal device 10 can receive the downlink voice data from the AP 30 after the terminal device 10 transmits a frame (e.g., PS-Poll (power save poll) frame) to the AP 30. A detailed description of such a voice data transmission can be understood from a voice data transmission method (described later) in accordance with one embodiment of the application, and thus such description is omitted here.

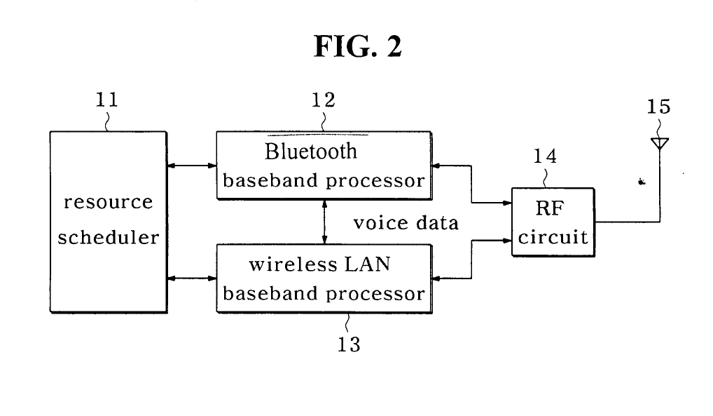

FIG. 2 provides a block diagram showing an example of the terminal device included in FIG. 1. However, embodiments of the application are not intended to be limited by such an exemplary disclosure. As shown in FIG. 2, the terminal device 10 can include a resource scheduler 11, a Bluetooth baseband processor 12, a wireless LAN baseband processor 13, an RF circuit 14 and an antenna 15.

The terminal device 10 can employ the single RF circuit 14 and antenna 15 although it includes two baseband processors 12 and 13. One reason the terminal device 10 can employ the single RF circuit 14 and antenna 15 is that the Bluetooth and the wireless LAN can use the same frequency band. However, embodiments of the application are not intended to be limited by such an exemplary disclosure. For example, the Bluetooth baseband processor 12 and the wireless LAN baseband processor 13 can be coupled with separate RF circuits and separate antennas, respectively, which can operate in the same, overlapping or different frequency bands.

The Bluetooth baseband processor 12 can transmit/receive data (e.g., voice) to/from the wireless LAN baseband processor 13. Uplink voice data transmitted from a headset (e.g., the headset 20) to the Bluetooth baseband processor 12 via the antenna 15 and the RF circuit 14 is sent to the wireless LAN baseband processor 13 and then the wireless LAN baseband processor 13 can transmit the sent uplink voice data to a network (e.g., to the AP 30 through the RF circuit 14 and the antenna 15). Further, downlink voice data transmitted from the AP 30 to the wireless LAN baseband processor 13 via the antenna 15 and the RF circuit 14 can be sent to the Bluetooth baseband processor 12 and then the Bluetooth baseband processor 12 transmits the sent downlink voice data to a headset (e.g., to the headset 20 through the RF circuit 14 and the antenna 15).

The terminal device can include a memory. For example, a buffer memory (not shown) can be coupled between the Bluetooth baseband processor 12 and the wireless LAN baseband processor 13 so that data (e.g., the sent voice data) can be stored temporarily before output (or processing).

The resource scheduler 11 can control a period during which the Bluetooth baseband processor 12 transmits and receives voice data and a period during which the wireless LAN baseband processor 13 transmits and receives voice data. For example, the resource scheduler 11 can control the above-mentioned periods such that the periods do not conflict with each other while the voice data are transmitted and received in a timely fashion, which can enable a voice conversation. Methods for controlling the Bluetooth baseband processor 12 and the wireless LAN baseband processor 13 by the resource scheduler 11 can be easily understood from method embodiments such as a voice data transmission method (described later) in accordance with an embodiment of the application, and thus their descriptions are omitted here.

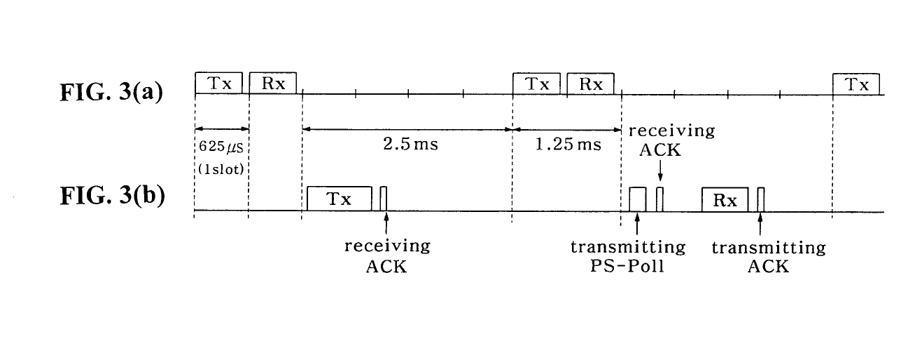

FIG. 3 is a diagram that illustrates a voice data transmission method in accordance with a first embodiment of the application. The voice data transmission method embodiment of FIG. 3 will be described using the embodiment of FIG. 1, however, the method embodiment of FIG. 3 is not intended to be limited thereby.

As shown in FIG. 3(a) shows a method for transmitting voice data between the terminal device 10 and the headset 20 by using the Bluetooth. FIG. 3 (b) illustrates a method for transmitting voice data between the terminal device 10 and the AP 30 by using the wireless LAN.

As shown in FIG. 3(a), the terminal device 10 can transmit downlink voice data to the headset 20 in a first slot and receive uplink voice data from the headset 20 in a second slot. Then, during subsequent (e.g., four) slots, the terminal device 10 may not transmit/receive voice data to/from the headset 20. Thereafter, the terminal device 10 can repeat the process of transmitting voice data and receiving voice data and interrupting a transmission/reception during subsequent (e.g., four) slots. Such a link repeating the transmission and the reception is referred to as SCO (synchronous connection oriented) link. The SCO link is mainly used in a voice communication.

As shown in FIG. 3, a method for performing a transmission/reception by using 2 slots among 6 slots and not performing a transmission/reception during the remaining 4 slots is referred to as HV3 (high quality voice 3). As shown in FIG. 3, one reason for using the HV3 is to carry out the wireless LAN communication during the period (e.g., four slots) when the Bluetooth transmission/reception is not performed. However, embodiments of the application are not intended to be limited by such an exemplary disclosure. For example, instead of using the HV3, in another embodiment it is possible to use HV2 (high quality voice 2) for performing a transmission/reception by using 4 slots among 6 slots and not performing a transmission/reception during the remaining 2 slots. However, since the HV2 has to conduct the wireless LAN communication only during 2 slots, there is a high possibility of being unable to perform the wireless LAN communication sufficiently. Accordingly, it is preferable to use the HV3 method in lieu of the HV2 method. Further, a HV1 method for performing the Bluetooth transmission/reception during all 6 slots among 6 slots can not be applicable to embodiments of the application.

Since the terminal device 10 can manage a timing for transmitting/receiving voice data, it is preferable that the terminal device 10 serves as a master while the headset 20 serves as a slave. However, embodiments of the application are not intended to be limited by such an exemplary disclosure.

As shown in FIG. 3(b), the wireless LAN communication can be conducted during the four slots within which the Bluetooth communication is not executed.

A process of transmitting uplink voice data to the AP 30 by the terminal device 10 during the wireless LAN communication can be easily carried out since the terminal device 10 can control the timing. For example, as shown in FIG. 3(b), the process can be enabled by transmitting the uplink voice data to the AP 30 and receiving ACK (acknowledgement) from the AP 30 by the terminal device 10. Further, since the wireless LAN can avoid a conflict based on CSMA/CA (carrier sense multiple access with collision avoidance), the terminal device 10 can transmit the uplink voice data to the AP 30 by using a period during which a conflict does not occur (e.g., in the four slots). In case that the uplink voice data cannot be transmitted during the four slots because of such conflicts, it is also possible to maintain a stand-by status and then to transmit voice data during the following period (e.g., 4 slots) within which the Bluetooth transmission/reception is not conducted.

Since a period during which the terminal device 10 receives voice data from the AP 30 by using the wireless LAN communication can be determined by the AP 30, the terminal device 10 may not control a timing for receiving voice data through the wireless LAN communication. Accordingly, the AP 30 can transmit downlink voice data to the terminal device 10 at any time, so that the Bluetooth transmission period may conflict with the transmission/reception period of the AP 30. Therefore, it may often occur that the downlink voice data cannot be transmitted from the AP 30 to the terminal device 10. At this time, the AP 30 can conduct a retransmission by lowering a transmission speed, e.g., by increasing a data transmission period in order to transmit voice data safely. However, if the data transmission period is increased, a probability of conflicting with the Bluetooth transmission/reception period can also be increased. Therefore, it can become more difficult in this case to transmit voice data from the AP 30 to the terminal device 10.

In order to reduce a likelihood of or to prevent such a situation and to control a timing for receiving voice data by the terminal device 10, embodiments of the application can make use of a PS-Poll (power save poll) frame. For example, the terminal device 10 can enter into a PS (power save) mode in order to prevent the AP 30 from transmitting voice data to the terminal device 10 at any time. A process of entering into the PS mode is not shown in FIG. 3(b). Thereafter, when the terminal device 10 wants to receive the downlink voice data from the AP 30, the terminal device 10 can send the PS-Poll frame to the AP 30. The AP 30 that received the PS-Poll frame can transmit ACK to the terminal device 10 and then send downlink voice data of one frame stored in the AP 30 to the terminal device 10. Upon receipt of the downlink voice data of one frame, the terminal device 10 can transmit ACK to the AP 30. Through such a process, the terminal device 10 can receive voice data from the AP 30. Since the terminal device 10 can transmit voice data to the AP 30 while maintaining the PS mode, it is preferable that the terminal device 10 maintain the PS mode while transmitting voice data to the AP 30. For example, it can be desirable that the terminal device 10 enters into the PS mode in advance before performing the voice data transmission.

Further, in one embodiment, the terminal device 10 can receive a Beacon frame periodically, and only when the Beacon frame indicates that there are data to be transmitted from the AP 30 to the terminal device 10, the terminal device 10 transmits the PS-Poll frame to the AP 30. For example, it is not needed for the terminal device 10 to transmit the PS-Poll frame to the AP 30 whenever it has an opportunity, and therefore, the terminal device 10 can transmit the PS-Poll frame to the AP 30 only when the Beacon frame previously received (e.g., immediate previous) indicates that there are data to be transmitted.

Although FIGS. 3(a)-3(b) illustrate one example of performing the wireless LAN transmission within the first four slots during which the Bluetooth transmission/reception is not conducted and executing the wireless LAN reception within the second four slots during which the Bluetooth transmission/reception is not performed, embodiments of the application are not intended to be so limited. For example, it is also possible to perform both of a transmission and a reception within a period (e.g., four slots) during which the Bluetooth transmission/reception is not conducted. However, since the four slots period is very short, e.g., 2.5 ms, it is preferable to separately perform a transmission and a reception.

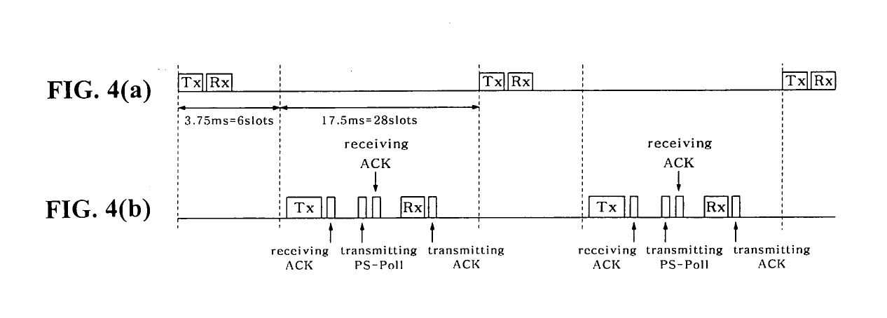

FIGS. 4(a)-4(b) are diagrams that illustrate a voice data transmission method in accordance with a second embodiment of the application. The voice data transmission method embodiment of FIG. 4 will be described using the embodiment of FIG. 1, however, the method embodiment of FIG. 4 is not intended to be limited thereby.

FIG. 4(a) shows a voice data transmission method using the Bluetooth between the terminal device 10 and the headset 20. FIG. 4(b) illustrates a voice data transmission method using the wireless LAN between the terminal device 10 and the AP 30. FIGS. 4(a)-4(b) show an exemplary non-limiting example where the Bluetooth uses eSCO (extended SCO) link.

As shown in FIG. 4(a) and FIG. 4(b), a first period (e.g., front 6 slots within cycle consisting of total number (e.g., 34) slots can be used in a voice data transmission/reception between the terminal device 10 and the headset 20 and during a second period (e.g., the remaining 28 slots), a voice data transmission/reception between the terminal device 10 and the headset 20 is preferably not performed. Since the eSCO method operating described uses 6 slots to conduct a voice data transmission/reception between the terminal device 10 and the headset 20 in comparison with the above-mentioned HV3 method, the eSCO method can be advantageous in that a retransmission of voice data is possible if an error occurs in a voice data transmission/reception. Further, since a period, during which a voice data transmission/reception between the terminal device 10 and the headset 20 is not performed, can correspond to 17.5 ms, it can be also advantageous because a voice data transmission/reception between the terminal device 10 and the AP 30 is enabled for a sufficient time. Preferably, within the longer period (e.g., the second period (17.5 ms) during which a voice data transmission/reception between the terminal device 10 and the headset 20 is not performed, a transmission/reception between the terminal device 10 and the AP 30 can be performed. Except for such differences, embodiments of voice data transmission methods shown in FIG. 4 are analogous to embodiments of voice data transmission methods shown and described with respect to FIG. 3, and thus their detailed descriptions are omitted here.

In case of employing the eSCO method, it is possible to adjust the cycle, the period during which the Bluetooth communication between the terminal device 10 and the headset 20 is performed and the period during which the Bluetooth communication between the terminal device 10 and the headset 20 is not performed. Accordingly, in the cycle of 34 slots, the period of 6 slots during which the Bluetooth communication is conducted and the period of 28 slots during which the Bluetooth communication is not conducted are merely exemplary and are not to be construed as limiting embodiments of the application.

As described above, by using the PS-Poll, the terminal device 10 can receive downlink voice data transmitted from the AP 30 safely within a limited period. However, even when the reception operation is controlled by using such embodiment, it can occur that the terminal device 10 fails to receive the downlink voice data. In such a case, the AP 30 can perform a retransmission by decreasing a transmission rate of voice data, e.g., by increasing a transmission period. However, if the transmission period of voice data is increased, a possibility of receiving the voice data by the terminal device 10 is lowered. Moreover, if the terminal device 10 again fails to receive the voice data from the AP 30, the transmission period can be increased still more, and in this case, situations can continue getting worse.

In order to prevent or reduce occurrence of such situations, in accordance with one embodiment of the application, the terminal device 10 can interrupt a communication with the headset 20 and preferentially receive the downlink voice data transmitted from the AP 30, e.g., when the terminal device 10 fails to receive the downlink voice data transmitted from the AP 30 a predetermined number of times. The predetermined number of times may be a once, e.g., one time, or a plural number. By using the above-described method, a situation where of continuously increasing the length of the downlink voice data transmitted from the AP 30 to the terminal device 10 can be reduced in likelihood or prevented.

Embodiments of methods and systems for transmitting data (e.g., voice) by using the first communication type (e.g., wireless LAN) and the second communication type (e.g., Bluetooth) in accordance with the application have various advantages. For example, a voice telephone communication using the headset wirelessly connected with the terminal device can be carried out by cooperatively managing resources of the wireless LAN and the Bluetooth employing the same frequency band.

Moreover, embodiments of methods and systems for transmitting voice data by using the wireless LAN and the Bluetooth can use a terminal device to control a reception timing of downlink voice data by using a data signal for prescribed communication patterns (e.g., the PS-Poll frame), to reduce or avoid transceiving conflict or solve problems caused by transmitting the downlink voice data from the AP to the terminal device at any time. Embodiments of methods and systems for transmitting voice data by using the wireless LAN and the Bluetooth can prevent the downlink voice data from being transmitted from the AP to the terminal device at any time by operating in a prescribed mode (e.g., the PS mode).

Further, embodiments of methods and systems for transmitting voice data by using the wireless LAN and the Bluetooth can reduce the likelihood or prevent the length of a frame including the downlink voice data transmitted by the AP from being increased by interrupting the Bluetooth communication with the headset and preferentially receiving the downlink voice data transmitted from the AP when the terminal device fails to receive the downlink voice data transmitted from the AP a prescribed number of times.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments. Furthermore, for ease of understanding, certain method procedures may have been delineated as separate procedures; however, these separately delineated procedures should not be construed as necessarily order dependent in their performance. That is, some procedures may be able to be performed in an alternative ordering, simultaneously, etc.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A voice data transmission method in a system including a terminal device, a headset to communicate with the terminal device according to a Bluetooth protocol and an access point (AP) to communicate with the terminal device according to a wireless LAN protocol, the method comprising:
performing a first communication between the terminal device and the headset during a first period of a cycle;
performing a second communication between the terminal device and the AP during a second period of the cycle, the second period being the remaining period from the cycle except the first period, the second communication including receiving downlink voice data from the AP by the terminal device; and
repeating said performing a first communication and said performing a second communication,
wherein said receiving downlink voice data from the AP by the terminal device, comprises,
transmitting a PS-Poll (power save poll) frame to the AP by the terminal device, and
receiving the downlink voice data from the AP by the terminal device in response to the PS-Poll frame.

2. The method of claim 1, comprising:
(d) making the terminal device enter to a PS (power save) mode prior to said performing.

3. The method of claim 1, comprising:
interrupting the communication with the headset and preferentially receiving the downlink voice data transmitted from the AP by the terminal device when the terminal device fails to receive the downlink voice data transmitted from the AP a predetermined number of times.

4. The method of claim 1, wherein said receiving downlink voice data from the AP by the terminal device comprises:
receiving an ACK frame from the AP after transmitting the PS-Poll frame; and
transmitting an ACK frame to the AP after receiving the downlink data from the AP in response to the PS-poll frame.

5. The method of claim 1, wherein the second communication comprises transmitting uplink voice data to the AP by the terminal device, and said transmitting the uplink voice data to the AP comprises,
transmitting the uplink voice data to the AP by the terminal device; and
receiving an ACK frame from the AP by the terminal device.

6. The method of claim 1, wherein said cycle consists of 6 slots and the first period consists of 2 slots and the second period consists of 4 slots.

7. The method of claim 1, wherein one of the receiving the downlink voice data from the AP and transmitting the uplink voice data to the AP is selectively performed during the second period.

8. The method of claim 1, wherein the terminal device communicates with the headset according to the Bluetooth protocol by using eSCO (extended synchronous connection oriented) method.

9. The method of claim 8, wherein both of the receiving the downlink voice data from the AP by the terminal device and transmitting the uplink voice data to the AP by the terminal device are carried out during the second period.

10. A system, comprising:
a headset;
an access point (AP); and
a terminal device to communicate with the headset according to a Bluetooth protocol to transmit downlink voice data to the headset and to receive uplink voice data from the headset and to communicate with the AP according to a wireless LAN protocol to transmit the uplink voice data to the AP and to receive the downlink voice data from the AP, the terminal device to send a power save poll (PS-Poll) frame to the AP to receive the downlink voice data from the AP responsive to the PS-Poll frame both within a period during which a transmission/reception between the terminal device and the headset is not to be performed.

11. The system of claim 10, wherein the terminal device is configured to transmit the uplink voice data to the AP within another period during which said transmission/reception between the terminal device and the headset is not performed.

12. The system of claim 10, wherein the terminal device is configured to operate in a power save (PS) mode.

13. The system of claim 10, wherein the terminal device comprises:
a Bluetooth baseband processor;
a wireless LAN baseband processor to transmit downlink voice data to the Bluetooth baseband processor and receive uplink voice data from the Bluetooth baseband processor;
an RF circuit coupled to the Bluetooth baseband processor and the wireless LAN baseband processor;
an antenna coupled to the RF circuit; and
a resource scheduler to control a period for the Bluetooth baseband processor to transmit the downlink voice data to the headset, a period for the Bluetooth baseband processor to receive the uplink voice data from the headset, a period for the wireless LAN baseband processor to transmit the uplink voice data to the AP, and a period for the wireless LAN baseband processor to receive the downlink voice data from the AP.

14. The system of claim 10, wherein the terminal device communicates with the headset periodically.

15. The system of claim 14, wherein the terminal device is configured to communicate with the headset according to the Bluetooth protocol by using HV2 (high quality voice 2) of SCO (synchronous connection oriented), HV3 of SCO or eSCO (extended SCO) method.

16. The system of claim 14, wherein the terminal device is configured to interrupt the communication with the headset and preferentially receive the downlink voice data transmitted from the AP when the downlink voice data transmitted from the AP is not received by the terminal device a predetermined number of times.

17. A terminal device, comprising:
a Bluetooth baseband processor;
a wireless LAN baseband processor to transmit/receive data to/from the Bluetooth baseband processor;
an RF circuit coupled to the Bluetooth baseband processor and the wireless LAN baseband processor;
an antenna coupled to the RF circuit; and
a resource scheduler to control the Bluetooth baseband processor to repeatedly perform a transmission and a reception, and to control the wireless LAN baseband processor to perform a transmission and a reception only within a period (during which the Bluetooth baseband processor does not perform the transmission and the reception), said resource scheduler to control the wireless LAN baseband processor to transmit a PS-Poll frame to an access point (AP) and receive data from the AP within said period.

18. The terminal device of claim 17, wherein the wireless LAN baseband processor is configured to operate in a power save (PS) mode.

19. The terminal device of claim 17, wherein the Bluetooth baseband processor is configured to perform a communication by using HV2 (high quality voice 2) of SCO (synchronous connection oriented), HV3 of SCO or eSCO (extended SCO) method.

20. The terminal device of claim 17, wherein the resource scheduler is configured to interrupt the periodic transmission and reception of the Bluetooth baseband processor and control the wireless LAN baseband processor to preferentially receive the data transmitted from the AP when the data transmitted from the AP is not received by the wireless LAN baseband processor a prescribed number of times.
